(19) United States
(12) Patent Application Publication
(10) Pub. No.: US 2004/0048765 A1
(43) Pub. Date: Mar. 11, 2004

(54) Composition

(76) Inventors: Anthony Michael Cooney, Northop (GB); Andrea Sneddon, Wirral (GB); John Martin Trainor, Chester (GB)

Correspondence Address: Eitan Pearl Latzer & Cohen Zedek, 10 Rockefeller Plaza, Suite 1001, New York, NY, 10020, US

(21) Appl. No.: 10/380,304

(22) PCT Filed: Sep. 10, 2001
(86) PCT No.: PCT/GB01/04054

(30) Foreign Application Priority Data
Sep. 13, 2000 (GB) 0022473.3

(51) Int. Cl. C11D 17/00

(52) U.S. Cl. 510/421

(57) ABSTRACT

There is provided a composition comprising (i) a detergent compound of the formula R¹-L-N(R²)(R³) wherein R¹ is a hydrocarbyl group has a number average molecular weight (Mn) of from 500 to 5000, L is an optional linker group; and R² and R³ are independently selected from H, a hydrocarbyl group, with the proviso that if one of R² and R³ is a hydrocarbyl group and the other of R² and R³ is H, the hydrocarbyl group does not contain a terminal amine; (ii) a carrier oil comprising an optionally esterified polyether.

This invention relates to multi-functional detergent-containing additive compositions for hydrocarbon fuels, more especially gasoline. More especially, the invention relates to alkenylsuccinimide-based detergent compositions for hydrocarbon fuels and especially gasoline.

Multi-functional detergent-containing additive compositions for gasoline have to satisfy a large number of criteria, amongst the most important of which are:

i) elimination of carburettor and injector fouling;

ii) good detergency in the intake port and intake valve regions of the engine;

iii) elimination of valve stick, a problem often associated with the use of high molecular weight detergents;

iv) corrosion protection;

v) good demulsifying characteristics.

WO-A-93/20170 discloses a composition comprising succinimide detergents and mono end-capped polypropylene glycol. Each of the specifically disclosed detergents is derived from a polyalkylene polyamine comprising two primary amine groups. The resultant succinimide detergent comprises a terminal amine group.

Some aspects of the present invention are defined in the appended claims.

In a first aspect the present invention provides a composition comprising (i) a detergent compound of the formula R¹-L-N(R²)(R³) wherein R¹ is a hydrocarbyl group has a number average molecular weight (Mn) of from 500 to 5000; L is an optional linker group; R² and R³ are independently selected from H, a hydrocarbyl group and a bond to optional group L, wherein at least one of R² and R³ is H or a hydrocarbyl group, with the proviso that if one of R² and R³ is a hydrocarbyl group and the other of R² and R³ is H, the hydrocarbyl group does not contain a terminal amine; (ii) a carrier oil comprising an optionally esterified polyether.

It has surprisingly been found that these new detergent compositions exhibit good valve stick performance and packagability.

In the present specification by the term “hydrocarbyl group” it is meant a group comprising at least C and H and may optionally compris one or more other suitable substituents. Examples of such substituents may include alkoxy-, nitro-, a hydrocarbon group, an N-acyl group, a cyclic group etc. In addition to the possibility of the substituents being a cyclic group, a combination of substituents may form a cyclic group. If the hydrocarbyl group comprises more than one C then those carbons need not necessarily be linked to each other. For example, at least two of the carbons may be linked via a suitable element or group. Thus, the hydrocarbyl group may contain hetero atoms. Suitable hetero atoms will be apparent to those skilled in the art and include, for instance, nitrogen and oxygen.

### Detergent Compound—R¹

Preferably R¹ is a hydrocarbon group. By the term “hydrocarbon group” it is meant a group comprising only C and H. The hydrocarbon group may be saturated or unsaturated. The hydrocarbon group may be straight chained or branched.

Preferably R¹ is a branched or straight chain alkyl group. More preferably R¹ is a branched alkyl group.

In a particularly preferred embodiment R¹ is polyisobutene.

Conventional and so called high reactivity polyisobutenes are suitable for use in the invention. High reactivity is defined as a polyisobutene wherein at least 50%, preferably 70% or more of the terminal olefinic double bonds are of the vinylidene type.

The preparation of polyisobutenyl substituted succinic anhydrides (PIBSA) is documented in the art. Suitable processes include thermally reacting a polyisobutenes with maleic anhydride (see for example U.S. Pat. No. 3,361,673 and U.S. Pat. No. 3,018,250), and reacting a halogenated, in particular a chlorinated, polyisobutene (PIB) with maleic anhydride (see for example U.S. Pat. No. 3,172,892). Alternatively, the polyisobutenyl succinic anhydride can be prepared by mixing the polyolefin with maleic anhydride and passing chlorine through the mixture (see for example GB-A-949,981).

The reaction product of these processes will be a complex mixture of unreacted polymer as well as the product polyisobutenyl succinic acid anhydride, the polyisobutenyl substituent being connected to either one or both of the alpha carbon atoms of the succinic acid group.

R¹ may have a molecular weight selected to provide the required properties of the detergent compound. In a preferred aspect R¹ has a molecular weight of from 800 to 1300. In a particularly preferred aspect R¹ is polyisobutene having a molecular weight of from 800 to 1300. The molecular weights are as determined by vapour phase osmometry or by gel permeation chromatography, on the originating polymer.

In one aspect R¹ may have from 10 to 200 carbons or from 10 to 100 carbons.

### Detergent Compound—Linker

The detergent compound of the formula R¹-L-N(R²)(R³) may or may not comprise optional linker L. If L is present it may be any suitable group. Suitable groups. include

C₁₋₆ hydrocarbyl groups optionally including one or more, preferably two, carbonyl groups,

C₁₋₆ hydrocarbon groups optionally including one or more, preferably two, carbonyl groups,

C₁₋₆ diacyl groups including groups of the formula

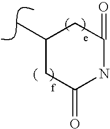

wherein e and f are independently an integer of from 0 to 6 and N is the nitrogen of group N(R²)(R ³)

diacyl groups derived from succinic anhydride including groups of the formula

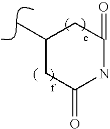

wherein e is 0 and f is 1 and N is the nitrogen of group N(R²)(R³)

### Detergent Compound—N(R²)(R³)

The detergent compound of the present invention contains a nitrogen moiety N(R²)(³) attache to the hydrocarbyl group R¹ via optional linker L. The groups end R² and R³ of the nitrogen moiety are independently H or a hydrocarbyl group. Thus

both R² and R³ may be H

one of R² and R³ may be H and the other of R² and R³ may be hydrocarbyl

both of R² and R³ may be hydrocarbyl.

R² and R³ are independently selected from H. a hydrocarbyl group and a bond to optional group L, wherein at least one of R² and R³ is H or a hydrocarbyl group. When one of R² and R³ is a bond to optional group L te nitrogen may contain either a double bond to a single atom of the group L or may be bonded to two different moieties of group L to form a cyclic group. Clearly if optional group L is not present these explanations equally apply to the connection between R¹ and N(R²)(R³).

It is requirement that when one of R² and R³ is a hydrocarbyl group and the other of R² and R³ is H. the hydrocarbyl group does not contain a term amine. in other words when one of R² and R³ is a hydrocarbyl group and the other of R² and R³ is H, if the hydrocarbyl group is an amine or polyamine the amine or amine units are selected rom secondary and tertiary amines.

Suitable terminal groups include —CH₃, ═CH₂, —OH, —C(O)OH and derivatives thereof. Suitable derivatives include esters and ethers.

Preferably the hydrocarbyl group R² and/or R³ does not contain a terminal amine. In other words if R² and/or R³ is a hydrocarbyl group selected from an amine or polyamine, the amine or amine units are selected from secondary and tertiary amines.

A preferred hydrocarbyl group for each of R² and R³ is a group of the formula

—[R⁴NH]ₚR⁶X

wherein R⁴ is an alkylene group haft from 1 to 10 carbons, preferably from 1 to 5, preferably 1 to 3 carbons, preferably 2 carbons;

wherein R⁵ is an alkylene group having from 1 to 10 carbons, preferably from 1 to 5, preferably 1 to 3 carbons, preferably 2 carbons;

wherein p is an integer from 0 to 10;

wherein X is selected from —CH₃, —CH₂═CH₂, —OH, and —C(O)OH.

A preferred hydrocarbyl group for each of R² and R³ is a group of the formula

—[(CH₂)_{q}NH]ₚ(CH₂)ᵣX

wherein p is an integer from 0 to 10, preferably 1 to 10, preferably from 1 to 5, preferably from 1 to 3, preferably 1 or 2;

wherein q is an integer from 1 to 10, preferably 1 to 10, preferably from 1 to 5, preferably from 1 to 3, preferably 1 or 2;

wherein r is an integer from 1 to 10, preferably 1 to 10, preferably from 1 to 5, preferably from 1 to 3, preferably 1 or 2; and

wherein X is selected from —CH₃, —CH₂═CH₂, —OH, and —C(O)OH.

Preferably X is —CH₃, or —OH.

The compounds of the present invention may be derived from a wide range of precursors. Embodiments of the present invention include compounds derived from amines selected from ammonia, butylamine, aminoethylethanolamine, aminopropan-2-ol, 5-aminopentan-1-ol, 2-(2-aminoethoxy)ethanol, monoethanolamine, 3-aminopropan-1-ol, 2-((3-aminopropyl)amino)ethanol, dimethylaminopropylamine, and N-(alkoxyalkyl)-alkanediamines including N-(octyloxyethyl)-1,2-diaminoethane and N-(decyloxypropyl)-N-methyl-1,3-diaminopropane.

The features described above may provide particularly preferred compounds in accordance with the present invention. These include compounds wherein

at least one of R² and R³ is a group of the formula —(CH₂)₃CH₃;

one of R² and R³ is a group of the formula —(CH₂)₃CH₃, and the other of R² and R³ is H;

at least one of R² and R³is a group of the formula —(CH₂)₂NH(CH₂)₂OH;

one of R² and R³ is a group of the formula —(CH₂)₂NH(CH₂)₂OH, and the other of R² and R³ is H; and

the detergent compound is a polyisobutenyl succinimide.

### Carrier Oil

The carrier oil may have any suitable molecular weight. A preferred molecular weight is in the range 500 to 5000.

In a preferred aspect the polyether carrier oil is a mono end-capped polypropylene glycol. Preferably the end cap is a group consisting of or containing a hydrocarbyl group having up to 30 carbon atoms. More preferably the end cap is or comprises an alkyl group having from 4 to 20 carbon atoms or from 12 to 18 carbon atoms.

The alkyl group may be branched or straight chain. Preferably it is a straight chain group.

Further hydrocarbyl end capping groups include alkyl-substituted phenyl, especially where the alkyl substituent(s) is or are alkyl groups of 4 to 20 carbon atoms, preferably 8 to 12, preferably straight chain.

The hydrocarbyl end capping group may be attached to the polyether via a linker group. Suitable end cap linker groups include an ether oxygen atom (—O—), an amine group —NH—), an amide group (—CONH—), or a carbonyl group —(C═O)—.

In a preferred embodiment the carrier oil is a polypropyleneglycol monoether of the formula:

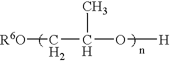

where R⁶ is straight chain C₁-C₃₀ alkyl, preferably C₄-C₂₀ alkyl, preferably C₁₂-C₁₈ alkyl; and n is an integer of from 10 to 50, preferably 10 to 30, more preferably 12 to 20.

Such alkyl polypropyleneglycol monoethers are obtainable by the polymerisation of propylene oxide using an aliphatic alcohol, preferably a straight chain primary alcohol of to 20 carbon atoms, as an initiator. If desired a proportion of the propyleneoxy units may be replaced by units derived from other C₂-C₆ alkylene oxides, e.g. ethylene oxide or isobutylene oxide, and are to be included within the term “polypropyleneglycol”. The initiator may also be a phenol or alkyl phenol of the formula R⁷OH, a hydrocarbyl amine or amide of the formula R⁷NH₂ or R⁷CONH, respectively, where R⁷ is C₁-C₂₀ hydrocarbyl group, preferably a saturated aliphatic or aromatic hydrocarbyl group such as alkyl, phenyl or phenalkyl etc. Preferred initiators include long chain alkanols giving rise to the long chain polypropyleneglycol monoalkyl ethers.

In a further aspect the polypropyleneglycol may be an ester (R⁶COO) group where R⁶ is defined above. In this aspect the carrier oil may be a polypropyleneglycol monoester of the formula

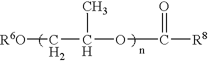

where R⁶ and n are as defined above and R8 is a C₁-C₃₀ hydrocarbyl group, preferably an aliphatic hydrocarbyl group, and more preferably C₁-C₁₀ alkyl.

### Composition

The detergent compound may be present in amount to provide the necessary and/or required handling and/or functional properties. Typically the detergent compound (including solvent of production) is present in an amount of from 10 to 60% by weight, preferably 30 to 60% by weight, based on the total composition. Typically the detergent compound (excluding solvent of production) is present in an amount of from 6 to 36% by weight, preferably 18 to 36% by weight, based on the total composition.

The carrier oil may be present in an amount of from 10 to 40% by weight, based on the total composition.

The weight ratio of detergent compound to carrier oil may be from 0.2:1 to 5:1.

In a preferred aspect the composition of the present invention further comprises a solvent. The solvent may be a hydrocarbon solvent having a boiling point in the range 66 to 320° C. Suitable solvents include xylene, toluene, white spirit, mixtures of aromatic solvents boiling in the range 180° C. to 270° C. (including aromatic solvent mixtures sold under the trade marks Shellsol AB, Shellsol R, Solvesso 150, Aromatic 150), and environmentally friendly solvents such as the low aromatic content solvents of the FINALAN range.

If present the amount of solvent to be incorporated will depend upon the desired final viscosity of the composition. Typically the solvent will be present in an amount of from 20 to 70% of the final composition on a weight basis.

In a preferred aspect the composition of the present invention comprises a solvent and a co-solvent. The co-solvent may be typically present in an amount of 1-2 wt. %. Suitable co-solvents include aliphatic alcohols (such as CAS no 66455-17-2)

The compositions of the present invention may contain a number of minor ingredients, often added to meet specific customer requirements. Included amongst these are dehazers, usually an alkoxylated phenol formaldehyde resin, added to minimise water adsorption and to prevent a hazy or cloudy appearance, and a corrosion inhibitor, usually of the type comprising a blend of one or more fatty acids and amines. Either or both may be present in the compositions of the present invention in amounts ranging from 1 to 5%, or I to 3% each, based on the total weight of the composition.

Other minor ingredients which may be added include anti-oxidants, anti-icing agents, metal deactivators, lubricity additives, friction modifiers, dehazers, corrosion inhibitors, dyes and the like. These may be added in amounts ranging from a few parts per million, up to 2 or 3% by weight, according to conventional practice.

In general terms the total amount of such minor functional ingredients in the composition will not exceed about 10% by weight, more usually not exceeding about 5% by weight.

Preferably the weight ratio of active detergent to carrier oil in the additive composition will be in the range 0.2:1 to 5:1, or 0.6:1 to 5:1, typically about 5:1, 2:1, 1:1, 0.9:1, 0.8:1, or 0.6:1.

Preferably the weight ratio of active detergent to carrier oil in the additive composition will be in the range 1:0.2to 1:1.8, or 1:0.3to 1:1.7, or 1:0.4to 1:1.6, or 1:0.5to 1:1.5, or 1:0.6 to 1:1.4, or 1:0.7 to 1:1.3, or 1:0.8 to 1:1.2 or 1:0.9 to 1:1.1, typically approximately 1:0.2, 1:0.5, 1:0.7, 1:1, 1:1.1, 1:1.2 or 1:1.6, such as 1:1.

### Fuel Composition

The composition of the present invention may be incorporated in fuel to provide a fuel composition. Thus in a further aspect the present invention provides a fuel composition comprising

(a) a composition comprising

(i) a detergent compound of the formula R¹-L-N(R²)(R³) wherein R¹ is a hydrocarbyl group has a number average molecular weight (Mn) of from 500 to 5000; L is an optional linker group; R² and R³ are independently selected from H. a hydrocarbyl group and a bond to optional group L, wherein at least one of R² and R³ is H or a hydrocarbyl group, with the proviso that if one of R² and R³ is a hydrocarbyl group and the other of R² and R³ is H, the hydrocarbyl group does not contain a terminal amine;

(ii) a carrier oil comprising an optionally esterified polyether; and

(b) a fuel

Preferably the fuel is a gasoline.

By the term “gasoline”, it is meant a liquid fuel for use with spark ignition engines (typically or preferably containing primarily or only C4C12 hydrocarbons) and satisfying international gasoline specifications, such as ASTM D-439 and EN228. The term includes blends of distillate hydrocarbon fuels with oxygenated components such as ethanol, as well as the distillate fuels themselves. The fuels may contain, in addition to the additive composition of the invention, any of the other additives conventionally added to gasoline as, for example, antiknock additives, anti-icing additives, octane requirement additives, lubricity additives etc.”

Preferably the composition is present in the fuel in an amount to provide on a weight basis, from 50 to 500 ppm detergent compound and 30 to 500 ppm carrier oil.

The present invention will now be described in further detail by way of Example only.

### EXAMPLES

### Synthesis of Detergents

### Example 1

1000 mwt PIBSA & Butylamine

1000 mwt high reactive PIB derived PIBSA (467.6 g) was stirred with Shellsol AB (311.8 g) in a 1I oil jacketed reactor equipped with an overhead stirrer, thermometer and Dean & Stark trap. Whilst still at room temperature butylamine (31.5 g) was added in one aliquot with continued stirring. An immediate exotherm was noted. The reaction mix was heated to ˜150° C. for three hours whilst removing water. 720 g of product was isolated.

Analysis of the product showed it to contain 40% m/m solvent, 0.81% m/m nitrogen.

### Example 2

1000 mwt PIBSA & Aminoethylethanolamine

1000 mwt high reactive PIB derived PIBSA (633.2 g) was stirred with Shellsol AB (421 g) in a 1I oil jacketed reactor equipped with an overhead stirrer, thermometer and Dean & Stark trap. Whilst still at room temperature aminoethylethanolamine (60.6 g) was added in one aliquot with continued stirring. An immediate exotherm was noted. The reaction mix was heated to 130-150° C. for three hours whilst removing water. 1058 g of product was isolated.

Analysis of the product showed it to contain 39% m/m solvent, 1.47% m/m nitrogen.

### Example 3

550 mwt PIBSA & Aminoethylethanolamine

550 mwt high reactive PIB derived PIBSA in Shellsol AB (900 g, 40% solvent) was stirred in a 1I oil jacketed reactor equipped with an overhead stirrer, thermometer and Dean & Stark trap. Aminoethylethanolamine (84.2 g) was added at room temperature whilst stirring. An exotherm was noted. The reaction mix was heated to 140° C. for four hours whilst removing water. 926 g of product was isolated.

Analysis of the product showed it to contain 38.5% m/m solvent, 2.33% rn/m nitrogen.

### Example 4

2300 mwt PIBSA & Butylamine

2300 mwt high reactive PIB derived PIBSA in Shellsol (495 g, 21.6% solvent) was stirred with extra Shellsol AB (110 g) in a 1I oil jacketed reactor equipped with an overhead stirrer, thermometer and Dean & Stark trap. Butylamine (9.37 g)was added at room temperature whilst stirring. The reaction mix was heated to 130° C. for three hours whilst removing water. 645 g of product was isolated.

Analysis of the product showed it to contain 38% m/m solvent, 0.35% m/m nitrogen.

### Example 5

2300 mwt PIBSA & Aminoethylethanolamine

2300 mwt high reactive PIB derived PIBSA in Shellsol (508 g, 21.6% solvent) was stirred with extra Shellsol AB (157 g) in a 1I oil jacketed reactor equipped with an overhead stirrer, thermometer and Dean & Stark trap. Aminoethylethanolamine (17.65 g) was added at room temperature whilst stirring. The reaction mix was heated to 140° C. for 3.5 hours whilst removing water. 838 g of product was isolated.

Analysis of the product showed it to contain 42% m/m solvent, 0.65% m/m nitrogen.

### Example 6

1000 mwt PIBSA & Ammonia

1000 mwt high reactive PIB derived PIBSA (450.15 g) was stirred with Shellsol AB (298.99 g) in a 1I oil jacketed reactor equipped with an overhead stirrer, thermometer, Dean & Stark trap and a dip tube through which to add ammonia. The temperature was taken up to 138° C. and the ammonia gas (5.81 g) was added over 3 hours, whilst collecting water in the trap. Heating was continued for a further 2 hours. 731 g of product was isolated.

Analysis of the product showed it to contain 40% m/m solvent, 0.76% m/m nitrogen.

### Test Data

### Example 7

Improved Packagability

Generally detergents such as polyisobutenyl succinimide (PIBSI) detergents and carrier fluids are incompatible without the addition of a suitable solvent. Many packages require additional solvent above the amount already present due to the manufacture of the detergent.

A series of packages were produced using a range of carriers and detergents. The following table shows the total percentage of solvent required to keep a 1:1 ratio of active detergent and carrier fluid package in one phase at ambient conditions. The lowest solvent content possible in this test is 25-26% due to the solvent associated with the detergent manufacture.

Amine used to produce detergent

| | Ammonia | Butylamine | Aminoethylethanolamine | Tetrasthylenepentamine |
|---|---|---|---|---|
| Carrier A | — | 26 | 25 | 25 |
| Carrier B | — | 26 | 25 | 30 |
| Carrier C | 25 | 26 | 25 | 37 |
| Carrier D | — | 26 | 30 | 40 |

Carrier A is a C₁₃₋₁₅ initiated polyether having 12 propylene oxide units attached
Carrier B is a C₁₃₋₁₅ initiated polyether having 14 propylene oxide units attached
Carrier C is a C₁₃₋₁₅ initiated polyether having 17 propylene oxide units attached
Carrier D is a nonylphenol initiated polyether having 17 propylene oxide units attached

Further storage stability testing has been carried out at −10° C., ambient and +40° C. over 5-7days. This showed that the amount of additional solvent required to keep a package, showing similar IVD performance, in one phase could be reduced by up to 60% by using the present invention.

### Example 8

Intake Valve Detergency

The intake valve detergency properties exhibited by the detergent/carrier oil combinations listed in the Table below were measured using industry standard CEC-F-05-A93 test procedure on a bench engine. The test engine was a Mercedes-Benz M 102.982 four cylinder, four stroke 2.3 litre gasoline-injection engine with a standard KE-Jettonic injection system. The test carried out involved a cyclic procedure, each cycle including the following four operating states:

| Stage | Time (min) | Speed (min-1) | Torques (Nm) | Power (kW) |
|---|---|---|---|---|
| 1 | 0.5 | 800 ± 50 | 0 ± 2 | 0 |
| 2 | 1.0 | 1,300 ± 50 | 29.4 ± 2 | 4 |
| 3 | 2.0 | 1,850 ± 50 | 32.5 ± 2 | 6.3 |
| 4 | 1.0 | 3,000 ± 50 | 35.0 ± 2 | 11.0 |

The duration of each test was exactly 60 h with the cycle repeated 800 times. At the beginning of each test the engine was fitted with new inlet valves which were weighed before fitting. At the end of each test, and before the visual assessment and before weighing the used inlet valves, residues were cleaned carefully from the valve surface facing the combustion space. The valves were then immersed in n-heptane for 10 seconds and swung dry. After drying for 10 minutes, the valves were weighed and the increase in valve weight caused by deposits was measured in mg. Visual assessment of the inlet valves was then carried out according to the rating system described in the CEC F-05-T-A93 method; the results are expressed in the Table below in the form of average per valve, a mark of 10 corresponding to a clean valve whilst a mark of 4.5 to a fouled valve. During the dismantling of the valves the sticky or non-sticky appearance of the deposits formed on the valve tulip and valve stem was also evaluated. The tendency to form deposits of sticky appearance could indicate, ultimately, a tendency to the appearance of the valve stick phenomenon which is desirable to avoid.

The fuel employed in the test procedure was an unleaded gasoline meeting EN228 specification. The test compositions were added to the fuel so as to obtain a concentration of active substance (detergent and carrier oil) in the fuel in the amounts indicated.

Using Carrier D as carrier, at 1:1.6 ratio of detergent:carrier

| Active treat | Detergent | IVD |
|---|---|---|
| 150 mg/l | 1000 mwt bis TEPA PIBSI | IVD = 82.1 mg/valve |
| 150 mg/l | 1000 mwt mono Butylamine PIBSI | IVD = 87.6 mg/valve |

Using Carrier A as carrier, at 1:1 ratio of detergent:carrier

| Active treat | Detergent | IVD |
|---|---|---|
| 245 mg/l | 1000 mwt bis TEPA PIBSI | IVD = 82 mg/valve |
| 245 mg/l | 1000 mwt AEEA PIBSI | IVD = 37 mg/valve |

Using carrier C, at 1:1 ratio of detergent:carrier in a fuel of low sulphur content.

| Active treat | Detergent | IVD |
|---|---|---|
| 254 mg/l | 1000 mwt AEEA PIBSI | IVD = 33.2 mg/valve |
| 350 mg/l | 1000 mwt AEEA PIBSI | IVD = 15.5 mg/valve |

### Example 9

Valve Stick Performance

A series of tests was also carried out to evaluate the actual valve stick properties of various formulations. Test running was carried out on a single roll distance accumulation dynamometer manufactured by Labeco. The test engine is a regular Volkswagen Transporter 1.9-liter, 44 kW water-cooled-boxer Otto engine type 2 series with hydraulic valve filter. It is a flat four cylinder engine mounted at the rear, with a three-speed automatic transmission. The cylinder heads are dismantled after each test (one test=3 runs on the same fuel) and are cleaned with a suitable cleansing agent until metallically clean. The valve guides and valve stems are measured before each test.

The fuel used in these tests is an unleaded gasoline meeting EN228 specification.

The procedure described by DKA (Deutscher Koordinierungs Ausschuess) CEC F-16-T-96. Each cycle including the following operating states:

Drive 130 km at level road load as follows:
5 km at 50 km/h
5 km at 60 km/h
Stop engine-pause 10 minutes
Carry out a total of 13 times to occupy 4 hours
33 minutes
Switch off engine and soak to temperature for
15 h
Carry out three cycles with a soak
temperature of +5° C.

At the end of each engine soak phase, an engine compression test is carried out to highlight any valve which is not functioning correctly. If compression at one or more of the cylinders is less than 8 bar then the inlet valve is deemed to have been sticking in the valve guide. For the final result, with a pass at −18° C., the same cycle is used except the soak temperature is -18° C. rather than 5° C.

The test compositions are added to the fuel so as to obtain a concentration of active substance in the fuel containing additives which is specified for each example in the Table below, which gives the results obtained.

| | | Total | Active detergent/ | Pass/ |
|---|---|---|---|---|
| Detergent | Carrier | active mg/l | carrier ratio | fail +5° C. |
| 1000/b/TEPA | D | 141 | 1:1.6 | Fail |
| 1000/ButA | A | 317 | 1:1.6 | Pass |
| 1000/AEEA | A | 317 | 1:1.6 | Pass |
| | | Total | Active detergent/ | Pass/ |
| Detergent | Carrier | active mg/l | carrier ratio | fail −18° C. |
| 1000/AEEA | A | 317 | 1:0.9 | Pass |
| 1000/AEEA | C | 317 | 1:1 | Pass |
| 1000/AEEA | C | 350 | 1:1 | Pass |

### Example 10

Intake Valve Detergency

The intake valve detergency properties exhibited by the detergent/carrier oil combinations listed have been measured using the CEC F-20-A-98 test procedure on a bench engine The test engine is a Mercedes Benz M111 four cylinder, four-stroke 2.0 litre gasoline-injection engine with four valves per cylinder and an electronically controlled ignition and fuel injection system. The test carried out involves a cyclic procedure, each cycle including the following four operating states:

| Stage | Time (min) | Speed (min-1) | Torque (Nm) |
|---|---|---|---|
| 1 | 0.5 | 750 ± 50 | Closed throttle |
| 2 | 1.0 | 1500 ± 25 | 40 ± 2 |
| 3 | 2.0 | 2500 ± 25 | 40 ± 2 |
| 4 | 1.0 | 3500 ± 25 | 40 ± 2 |

The duration of each test is 60 hours. At the beginning of each test, the engine is fitted with new inlet valves, which are weighed before fitting. At the end of each test, and before weighing of the used inlet valves, residues are cleaned carefully from the valve surface facing the combustion space. The valves are then immersed in n-heptane for 10 seconds and air dried for at least 10 minutes and a maximum of 2 hours. Each valve is then weighed on a precision scale to an accuracy of at least one milligram, to determine the total weight of the valve and all its deposits.

The inlet valve deposit weight is determined by subtracting the weight of the clean intake valve that was determined before commencement of test and expressed in mg/cylinder.

The fuel employed was an unleaded gasoline meeting EN228 specification.

Using Carrier C as carrier, at a 1:1 ratio of detergent:carrier,

| Active Treat mg/l | Detergent | IVD mg/valve |
|---|---|---|
| 188 | 1000 mwt AEEA PIBSI | 106.2 |
| 212 | 1000 mwt AEEA PIBSI | 119.7 |
| 254 | 1000 mwt AEEA PIBSI | 63.6 |
| 306 | 1000 mwt AEEA PIBSI | 27.3 |

All publications mentioned in the above specification are herein incorporated by reference. Various modifications and variations of the described methods and system of the invention will be apparent to those skilled in the art without departing from the scope and spirit of the invention. Although the invention has been described in connection with specific preferred embodiments, it should be understood that the invention as claimed should not be unduly limited to such specific embodiments. Indeed, various modifications of the described modes for carrying out the invention which are obvious to those skilled in chemistry or related fields are intended to be within the scope of the following claims.

1. A composition comprising
(i) a detergent compound of the formula
R¹-L-N(R²)(R³)
wherein
R¹ is a hydrocarbyl group has a number average molecular weight (Mn) of from 500 to 5000;
L is an optional linker group; and
R² and R³ are independently selected from h, a hydrocarbyl group and a bond to optional group L, wherein at least one of R² and R³ is h or a hydrocarbyl group, with the proviso that if one of R² and R³ is a hydrocarbyl group and the other of R² and R³ is H, the hydrocarbyl group does not contain a terminal amine;
(ii) a carrier oil comprising an optionally esterified polyether.

2. A composition according to claim 1 wherein R¹ is a hydrocarbon group.

3. A composition according to claim 1 or 2 wherein R¹ is a branched or straight chain alkyl group.

4. A composition according to claim 3 wherein R¹ is a branched alkyl group.

5. A composition according to claim 2, 3 or 4 wherein R¹ is polyisobutene.

6. A composition according to any one of the preceding claims wherein R¹ has a molecular weight of from 800 to 1300.

7. A composition according to claim 5 wherein R¹ is polyisobutene having a molecular weight of from 800 to 1300.

8. A composition according to any one of the preceding claims wherein group R¹ has from 10 to 200 carbons.

9. A composition according to any one of the preceding claims wherein group R¹ has from 10 to 100 carbons.

10. A composition according to any one of the preceding claims wherein the detergent compound comprises linker L.

11. A composition according to any one of the preceding claims wherein L is a group of the formula 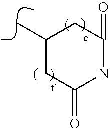
wherein e and f are independently an integer of from 0 to 6 and N is the nitrogen of group N(R²)(R³).

12. A composition according to any one of the preceding claims wherein both R² and R³ are H.

13. A composition according to any one of claims 1 to 11 wherein at least one of R² and R³ is a hydrocarbyl group.

14. A composition according to claim 13 wherein at least one of R² and R³ is a hydrocarbyl group terminated with a moiety selected from —CH₃, ═CH₂, —OH, —C(O)OH, and derivatives thereof.

15. A composition according to claim 13 or 14 wherein at least one of R² and R³ is a hydrocarbyl group of the formula
—[R⁴NH]ₚR⁵X
wherein R⁴ is an alkylene group having from 1 to 10 carbons
wherein R⁵ is an alkylene group having from 1 to 10 carbons
wherein p is an integer from 0 to 10;
wherein X is selected from —CH₃, —CH₂═CH₂, —OH, and —C(O)OH.

16. A composition according to claim 15 wherein R⁴ is an alkylene group having from 1 to 5, preferably 1 to 3 carbons, preferably 2 carbons.

17. A composition according to claim 15 or 16 wherein R⁵ is an alkylene group having from 1 to 5, preferably 1 to 3 carbons, preferably 2 carbons.

18. A composition according to claim 15 wherein at least one of R² and R³ is a hydrocarbyl group of the formula
—[(CH₂)_{q}NH]ₚ(CH₂)ᵣX
wherein p is an integer from 0 to 10;
wherein q is an integer from 1 to 10;
wherein r is an integer from 1 to 10; and
wherein X is selected from —CH₃, —CH₂═CH_{2,} —OH, and —C(O)OH.

19. A composition according to claim 18 wherein p is an integer from 1 to 10, preferably from 1 to 5, preferably from 1 to 3, preferably 1 or 2.

20. A composition according to claim 18 or 19 wherein q is an integer from 1 to 10, preferably from 1 to 5, preferably from 1 to 3, preferably 1 or 2.

21. A composition according to claim 18, 19 or 20 wherein r is an integer from 1 to 10, preferably from 1 to 5, preferably from 1 to 3, preferably 1 or 2.

22. A composition according to any one of claims 15 to 21 wherein X is selected from —CH₃, and —OH.

23. A composition according to any one of claims 15 to 22 wherein at least one of R² and R³ is a group of the formula —(CH₂)₃CH₃.

24. A composition according to claim 23 wherein one of R² and R³ is a group of the formula —(CH₂)₃CH₃, and the other of R² and R³ is H.

25. A composition according to any one of claims 15 to 22 wherein at least one of R² and R³ is a group of the formula —(CH₂)₂NH(CH₂)₂OH.

26. A composition according to claim 25 wherein one of R² and R³ is a group of the formula —(CH₂)₂NH(CH₂)₂OH, and the other of R² and R³ is H.

27. A composition according to any one of the preceding claims wherein the detergent compound is a polyisobutenyl succinimide.

28. A composition according to any one of the preceding claims wherein the polyether carrier oil has a molecular weight in the range 500 to 5000.

29. A composition according to any one of the preceding claims wherein the polyether carrier oil is a mono end-capped polypropylene glycol.

30. A composition according to claim 29 wherein the end cap is a group consisting of or containing a hydrocarbyl group having up to 30 carbon atoms.

31. A composition according to claim 30 wherein the end cap is or comprises an alkyl group having from 4 to 20 carbon atoms.

32. A composition according to claim 29 wherein the carrier oil is a polypropyleneglycol monoether of the formula: 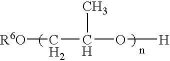
where R⁶ is straight chain C₁₂-C₁₈ alkyl; and n is an integer of from 10 to 30.

33. A composition according to any one of the preceding claims wherein the detergent compound is present in an amount of from 10 to 60% by weight, preferably 30 to 60 & by weight, based on the total composition.

34. A composition according to any one of the preceding claims wherein the carrier oil is present in an amount of from 10 to 40% by weight, based on the total composition.

35. A composition according to any one of the preceding claims wherein the weight ratio of detergent compound to carrier oil is from 0.2:1 to 5:1.

36. A composition according to any one of the preceding claims wherein further comprising a solvent.

37. A composition according to claim 36 the solvent is a hydrocarbon solvent having a boiling point in the range 66 to 320° C.

38. A fuel composition comprising
(a) a composition as defined in any one of claims 1 to 37; and
(b) a fuel

39. A fuel according to claim 38 wherein the fuel is a gasoline.

40. A fuel according to claim 38 or 39 wherein the composition is present in an amount to provide on a weight basis, from 50 to 500 ppm detergent compound and 30 to 500 ppm carrier oil.

41. A composition as substantially herein before described with reference to any one of the Examples.

42. A fuel composition as substantially herein before described with reference to any one of the Examples.
